(19) United States
(12) Patent Application Publication
(10) Pub. No.: US 2004/0235376 A1
(43) Pub. Date: Nov. 25, 2004

(54) Vehicle interior trim component containing carbon fibers and method of manufacturing the same

(76) Inventors: George B. Byma, Clarkston, MI (US); Brian A. Cristea, Royal Oak, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/601,615

(22) Filed: Jun. 23, 2003

Related U.S. Application Data
(63) Continuation-in-part of application No. 10/440,889, filed on May 19, 2003.

(51) Int. Cl. B32B 27/12; B32B 27/02; B32B 27/04

(52) U.S. Cl. 442/38; 442/21; 442/43; 442/45; 442/46; 442/49

(57) ABSTRACT

A structural reinforcement layer for use in a laminate for a vehicle headliner comprises at least one of carbon fibers and natural fibers. A thermoplastic binder may adhere the fibers to one another. A method for manufacturing a laminate comprising a the structural reinforcement layer comprises the steps of providing a core, providing a first reinforcement layer containing carbon fibers adjacent one of opposing sides of the core, providing adhesive layers on each of the opposing sides of the core, applying a barrier film and covering to the first reinforcement layer to the first reinforcement layer. Applying a scrim mat comprising a reinforcement layer, a barrier film and a scrim layer to the other of the opposing sides of the core to complete the laminate. According to a method for recycling a laminate, laminate material formed of composite materials including carbon fibers that have a melting and/or degradation point above the incineration point of the other composite materials is provided. The laminate is heated to a temperature below the melting and/or degradation point of the carbon fibers and above the incineration point of the other composite materials to reduce the other composite materials to ash.

### CROSS REFERENCE TO RELATED APPLICATIONS

This application is a continuation-in-part of U.S. patent application Ser. No. 10/440,889 filed May 19, 2003, the disclosure of which is incorporated herein by reference.

### BACKGROUND OF INVENTION

The present invention pertains generally to the molding of composite materials, including fibers and plastics and, more particularly, to the molding of structural and acoustical panels, which include carbon fibers and thermoset resins.

Composite material panels are used in many different applications, including automobiles, airplanes, trains, and housing and building construction. The properties sought in such panels are strength, rigidity, sound absorption, and heat and moisture resistance. One application of such panels that has been especially challenging is vehicle headliners and other vehicle interior panels. Many different types of laminates and laminated composites have been tested and produced for use in automobiles and other vehicles.

Some vehicle headliners have a core of glass fibers and a polyester resin. Others have a core of open cell polyurethane foam impregnated with a thermosetting resin and a reinforcing layer of fiberglass. Still others have a first fiber-reinforcing mat, such as a glass fiber mat, on one side of a fibrous core and a second fiber-reinforcing mat on the opposite side to form a laminate. The exposed surfaces of the reinforcing mats are then coated with a resin and an outer covering is applied. The composite or laminate is ultimately formed to a desired shape under heat and pressure (i.e., compression molding) and cut to a desired size by a trimmer.

Although manufacturers strive to minimize the amount of material that is removed from the headliner when trimmed, some material is still removed. It is desirable, and sometimes required, that the material removed during trimming be recycled as well as some or all of the materials of the headliner at the end of the life cycle of the headliner. One method of recycling that is gaining popularity involves incineration and reclamation of the energy resulting from the incineration.

Regardless of the method of construction, headliners containing glass fibers shorten the life of the furnace used for recycling. This occurs because the furnace must be heated to a temperature that exceeds the melting point of the glass in order to reduce the other composite materials to ash. The melted glass coats the furnace and solidifies when cooled. The solid glass is difficult to remove from the incinerator walls. Therefore, it would be desirable to manufacture a headliner with a composition that meets the desired functional requirements and is more suitable for recycling.

### SUMMARY OF INVENTION

The present invention is directed toward a vehicle panel that meets the foregoing needs. More particularly, the invention is directed toward a structural reinforcement layer, or mat, for use in a vehicle headliner. The mat may comprise a portion of a laminate for use as a headliner. The mat is at least partially comprised of carbon fibers, and may include a thermoplastic binder. As referenced throughout this application, carbon fibers may be any fiber comprised at least partially of any material commonly known in the materials industry as “carbon fiber” or “graphite fiber” with the tensile strength properties as described herein. For example, carbon fibers may be defined as: a material made by pyrolyzing any spun, felted, or woven raw material to a char; any high-tensile fibers or whiskers made from rayon, polyacrylonitrile (PAN), or petroleum pitch; polyacrylonitrile that has undergone oxidization and carbonization; and/or any of the previously listed materials additionally including surface treatments or sizings, for example, neutral finishing agents to protect the fibers during further processing or prepregging resins or epoxies, or any combination of the previously listed materials as a bicompound or hybrid fiber. It is believed that preferably, the carbon fibers are formed from petroleum pitch, and more preferably petroleum reside, that has undergone oxidization and carbonization. Petroleum pitch may include, for example, petroleum residues, asphalt, coal tar, etc. In a preferred embodiment, the mat also includes natural fibers, such as sissal, hemp, knaf, flax, or wood.

The laminate may comprise a core having adhesive layers adjacent opposing sides thereof. The laminate comprises at least one mat including carbon fibers. The mat may be provided adjacent each adhesive layer. A scrim layer and barrier film are provided next to one mat while a barrier film and covering are provided adjacent the other mat.

The invention is also directed toward a method for manufacturing a laminate including a mat comprising carbon fibers. The method comprises the steps of providing a first layer comprising a layer of carbon fibers and thermoplastic binder, a barrier film, and a scrim layer, that have been bonded together, preferably by a heat process. A core is provided and adhesive layers are roll coated onto opposing sides of the core. The first layer is adhered to a first side of the core, such that the scrim layer of the first layer is an outer surface of the laminate. A carbon fiber mat, a barrier film and a cover are adhered to a second side of the laminate, such that the cover is an outer surface of the laminate.

The invention is further directed toward a method for recycling laminate material. The method comprises the steps of providing a laminate material formed of composite materials including reinforcement fibers that have at least one of a melting and degradation point above the incineration point of the other composite materials, and heating the laminate to a temperature below the melting and/or degradation point of the carbon fibers and above the incineration point of the other composite materials to reduce at least a portion of the other composite materials to ash without reducing the carbon fibers to a nonpolycrystalline or degraded state.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a schematic representation of a laminate, according to a preferred embodiment of the invention.

FIG. 2 is a schematic representation of a manufacturing assembly for producing the laminate shown in FIG. 1, in accordance with a method of manufacture according to a preferred embodiment of the invention.

FIG. 3 is a schematic representation of the scrim mat of the laminate shown in FIGS. 1 and 2, according to a preferred embodiment of the invention.

### DETAILED DESCRIPTION

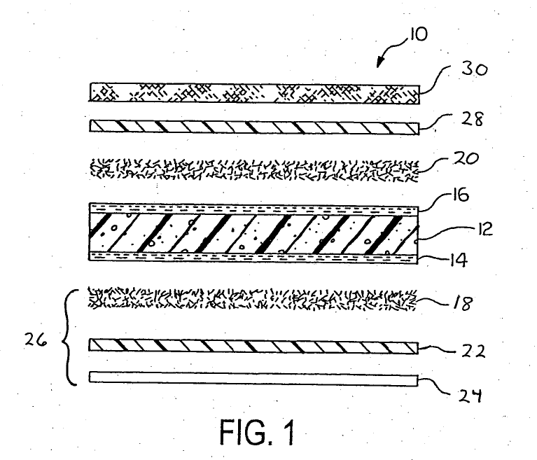

Now with reference to the drawings, wherein like numerals designate like components throughout all of the several figures, there is schematically represented in FIG. 1 a laminate, collectively referenced at 10, according to a preferred embodiment of the invention, for use as a vehicle headliner. The laminate 10 is made up of combined materials including a core 12. A layer of adhesive 14, 16, preferably a liquid adhesive layer, is applied to opposing sides of the core 12 (i.e., above and below the core 10 when viewing FIG. 1). Structural reinforcement layers or mats 18, 20 are provided on each side to the core 12, each adjacent a corresponding layer of liquid adhesive 14, 16. A barrier film 22 and a scrim layer 24 are provided adjacent the adhesive layer 14 on the core 12 (i.e., at the bottom of the laminate 10 when viewing FIG. 1) next to a corresponding reinforcement layer 18. The structural reinforcement layer 18, barrier film 22, and scrim layer 24 may be pre-assembled into a scrim mat 26 prior to incorporation into the laminate 10, as will be described below. A barrier film 28 and covering 30 are provided adjacent the adhesive layer 16 on the core 12 (i.e., atop the laminate 10 when viewing FIG. 1) next to a corresponding reinforcement layer 20.

The illustrated laminate is intended merely to illustrate one environment in which this invention may be used. Thus, the scope of this invention is not intended to be limited for use with the specific structure for the laminate 10 illustrated in FIG. 1 or with headliners in general. On the contrary, as will become apparent below, the structural reinforcement layers 18, 20 of this invention may be used in any desired environment for the purposes described below. It will be appreciated that any number of structural reinforcement layers as described below, including a single layer, may be incorporated into the laminate 10, or otherwise included in a vehicle panel or headliner in accordance with this invention.

It should be appreciated that the optional adhesive layers 14, 16 need not be applied to the core 12 but instead may be applied to the structural reinforcement layers 18, 20, or to both the core 12 and the structural reinforcement layers 18, 20. It should also be appreciated that the adhesive layers 14, 16 are not intended to be limited to liquid, but may be any adhesive suitable for carrying out the invention.

The core 12 is most preferably made of polyurethane resin (PUR) foam due to its light weight, compression resistance, moldability, acoustic absorption, and ability to allow engineered solutions to automotive overhead systems problems. The core 12 may vary in thickness and density and internal load deflection (ILD). For example, the core 12 may have a thickness in a range from about 2 mm to about 30 mm and a density in a range from about 1.0 lb/ft³ to about 3.5 lb/ft³. The composition, thickness, and density of the core 12 depend upon depth of draw (i.e., the vertical dimension that the laminate 10 will deviate from a flat horizontal plane), acoustical requirements, and load bearing requirements. It should be understood that the aforementioned core compositions and thickness and density ranges are given as examples and that the invention is not limited to such compositions or ranges.

The adhesive layers 14, 16 are preferably in the form of an elastomeric thermosetting liquid resin, such as polyurethane adhesive. One preferred adhesive is Forbo 2U010/22014, manufactured by Forbo Adhesives, LLC, of Research Triangle Park, N.C. The weight of the adhesive layers 14, 16 may be in a range from about 20 g/m² to about 200 g/m² and is most preferably about 35 g/m² to about 50 g/m² to wet out the reinforcing fibers and achieve bonds to the adjacent material layers. The adhesive layers 14, 16 may be applied by a conventional roll coating process, or any other suitable coating process for applying the adhesive layers 14, 16 to the surfaces of the core 12. As stated above, the adhesive layers 14, 16 may alternatively be applied to the reinforcement layers 18, 20, or to both the core 12 and the reinforcement layers 18, 20. Although some surface saturation may occur, the core 12 is preferably not impregnated with liquid adhesive. This is because the primary function of the adhesive is to bond the reinforcing fibers to the core 12 and this occurs on the surface. The adhesive layers 14, 16, when heated, in the presence of catalyst, react to form a thermoset. This catalyzed reaction causes the adhesive to cure and the laminated structure to become rigid. It should be understood that the aforementioned adhesive layer weights are given as examples and that the invention is not limited to such weights.

The structural reinforcement layers 18, 20 are preferably comprised of fibers, and more preferably include at least a portion of carbon fibers. It will be appreciated that at least one of the structural reinforcement layers 18, 20 may be formed completely of carbon fibers, natural fibers, or any combination thereof. It will also be appreciated that at least one of the structural reinforcement layers 18, 20 may contain additional fibers with a melting and/or degradation point above the incineration point of the materials that are not carbon fibers in the structural reinforcement layer. For example, the additional fibers may be basalt. The natural fibers are preferably any fiber that can be incinerated into ash at a temperature lower than a temperature at which carbon fibers would melt and/or break-down and adhere to an incinerator. Natural fibers are preferred since they do not coat an incinerator during such an incineration process. Suitable examples of natural fibers include sissal, hemp, knaf, flax, and wood.

The carbon fibers included in at least one of the structural reinforcement layers 18, 20 may be any fiber comprised at least partially of any material commonly known in the materials industry as “carbon fiber” or “graphite fiber” with the tensile strength properties as described herein. For example, carbon fibers may be defined as: a material made by pyrolyzing any spun, felted, or woven raw material to a char; any high-tensile fibers or whiskers made from rayon, polyacrylonitrile (PAN), or petroleum pitch; polyacrylonitrile that has undergone oxidization and carbonization and/or graphitization; and/or any of the previously listed materials additionally including surface treatments or sizings, for example, neutral finishing agents to protect the fibers during further processing or prepregging resins or epoxies, or any combination of the previously listed materials as a bicompound or hybrid fiber. It is believed that preferably, the carbon fibers are produced from petroleum pitch, and more preferably petroleum reside, that has undergone oxidization and carbonization. Petroleum pitch may include, for example, petroleum residues, asphalt, coal tar, etc. Petroleum pitch is widely available from the petroleum industry, and carbon fibers produced from petroleum pitch are also widely available and are not cost prohibitive for the uses described herein.

In a preferred embodiment, at least one of the structural reinforcement layers 18, 20 includes carbon fibers such that the carbon fibers comprise 50% or greater of the total weight of the at least one structural reinforcement layers 18, 20. It has been found that a structural reinforcement layer having carbon fibers comprising 50% or greater of the total weight provides sufficient strength, while minimizing cost. A structural reinforcement layer 18 and/or 20 comprised of carbon fibers provides an extremely rigid and strong substrate layer. Carbon fibers have been found to be far superior in tensile strength compared to conventionally used fibers, such as glass. However, carbon fibers are relatively expensive compared to conventionally used fibers and have, therefore, not been used in the industry. An embodiment of the present invention combines carbon fibers with less expensive fibers such as natural fibers, to reduce overall cost yet provide a sufficiently strong substrate. It is believed that carbon fibers are ideally suited for use in vehicle headliners due to the advantages described in connection with the carbon fiber characteristics of low weight, high strength, availability, and high melting and degradation points, as is described throughout this application.

The fibers of the structural reinforcement layers 18, 20 may be continuous or chopped and may be coated with a sizing treatment, which makes the fibers highly compatible with the thermosetting liquid resin. The structural reinforcement layers 18, 20 may include a binder, such as a thermoplastic material, to bind the fibers to one another. The binder may be combined with the carbon fibers in any manner, including, for example, addition as a surface treatment or sizing applied on or impregnated in the carbon fibers prior to or during formation of the structural reinforcement layers 18, 20. The carbon fibers may include surface treatments or sizings in addition to the binder. The carbon fibers and any other fibers desired to comprise the structural reinforcement layers 18, 20 may be combined with a binder in any conventional manner to form the structural reinforcement layers 18, 20. Loose carbon fibers and the other desired fibers may be gravity fed onto another layer of the laminate 10 into an adhesive or binder material coating, or a binder or adhesive may be sprayed onto any layer of the laminate 10 or fibers to form the structural reinforcement layers 18, 20. Additional equipment such as equipment to control the disbursement of loose carbon fibers by electrostatic charge may be required if loose carbon fibers are used to produce the laminate 10. Therefore, it is believed to be preferable that the laminate 10 includes pre-formed structural reinforcement layers 18, 20.

The structural reinforcement layers 18, 20 preferably have a weight in a range from about 20 g/m² to about 200 g/m² to create a composite of appropriate strength and stiffness to meet OEM requirements for vehicle headliners, although other weights may be suitable for carrying out the invention. Carbon fibers have a high tensile strength as compared to other fibers conventionally used in vehicle headliners, such as E-glass fibers. At least one of the melting point and degradation point of carbon fibers is higher than that of the melting point of E-glass fibers. This makes carbon fibers superior to E-glass fibers in terms of recycling by incineration, energy reclamation, and tensile strength, as will become more apparent in the description that follows.

The barrier film 22 is preferably made of thermoplastic. The barrier film 22 is preferably substantially imperforate. In addition, the barrier film 22 preferably has a great affinity for the scrim 24,the adhesive layer 14, and the carbon fibers of the structural reinforcement layer 18, so that the layers above and below the barrier film 22 readily adhere to the barrier film 22. Furthermore, the barrier film 22 may provide a barrier for preventing the adhesive layer 14 from bleeding into or through scrim 24, causing permanent surface imperfections in the laminate 10, and leaving adhesive residue on the forming die and/or conveyor systems used in the manufacturing process.

The scrim layer 24 is preferably made of a lightweight polymer or plastic, such as polyethylene terephthalate (PET), nylon, or blends thereof. The scrim layer 24 may be a woven, non-woven, or film backing or barrier. Moreover, the scrim layer 24 may be a bi-laminate formed of a scrim and a barrier, such that the barrier film 22 is incorporated into the scrim layer 24. The melting point of the scrim layer 24 is preferably higher than the forming die temperature so that the scrim layer 24 does not stick to the die. The scrim layer 24 may function to retain the resin within the laminate 10 and thereby prevent the thermosetting resin from reaching the forming die surface of a mold, as will become apparent in the description that follows. Hence, the scrim layer 24 may aid in releasing the laminate 10 from the forming die. This works for polymeric scrims as long as the melting point is above the forming die temperature, as stated above. The scrim layer 24 may also be used to bond with and add strength or provide additional rigidity to the adjacent reinforcement layer 18, assist in holding the adjacent reinforcement layer 18 together, and/or have shape-retention properties. Furthermore, the scrim layer 24 preferably provides a finished surface for mounting against the roof of an automobile and prevents or reduces vibration or abrasion noise when in contact with the roof.

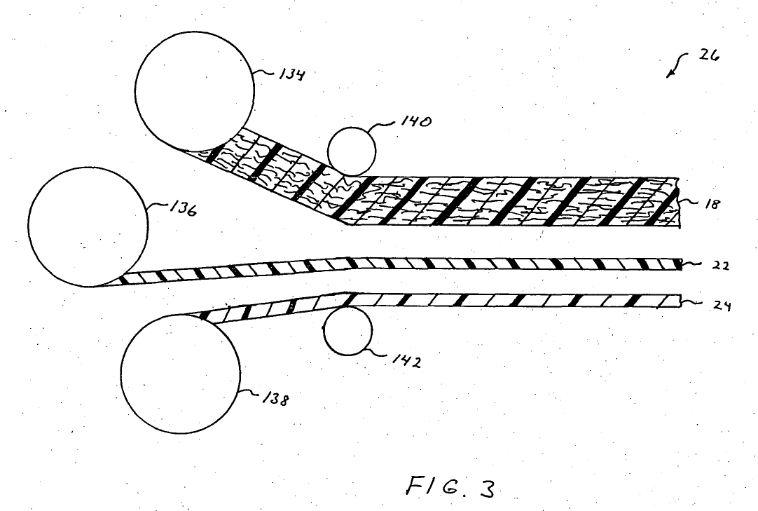

The structural reinforcement layer 18, barrier film 22, and scrim layer 24 may be pre-assembled into a scrim mat 26 before incorporation into the laminate 10, as shown in FIG. 3. The layers of the scrim mat 26 may be adhered to one another by any suitable method, such as a heat process and/or by a separate adhesive. The scrim mat 26 may be incorporated into the laminate 10, as will be described below. However, it will be appreciated the structural reinforcement layer 18, barrier film 22, and scrim layer 24 may be incorporated individually into the laminate 10 by any suitable method.

The barrier film 28 is made of thermoplastic, and may be similar in structure to the barrier film 24. The barrier film 28 preferably has a great affinity for the covering 30, the adhesive layer 16, and the carbon fibers of the structural reinforcement layer 20 so that the layers above and below the barrier film 28 readily adhere to the barrier film 28. Furthermore, the barrier film 28 may provide a barrier for preventing the adhesive layer 16 from bleeding into or through covering 30, causing permanent surface imperfections in the laminate 10, and leaving adhesive residue on the forming die and/or conveyor systems used in the manufacturing process.

The covering 30 is applied over the barrier film 28 to complete the laminate 10. The covering 30 is preferably made of fabric or cloth (e.g., a headliner fabric), which may be a woven or non-woven textile with a polymer base, such as a knit nylon or polyester. Alternatively, the covering 30 may be made of vinyl, leather, or the like. The covering 30 may be decorative to provide an aesthetically pleasing finished surface and preferably has a flexible character, which includes sufficient stretch characteristics to allow the covering to match the design surface of the headliner. If a soft feel to the covering 30 is desired, the covering 30 may include an additional substrate, such as a polyester or polyester polyurethane foam (not shown), as is commonly known to one skilled in the art. The foam may also function as an acoustical absorption material.

Alternatively, it will be appreciated that the structural reinforcement layer 20, barrier film 28, and covering 30 may be pre-assembled into a mat (not shown) before incorporation into the laminate 10, in a manner similar to that described for the scrim mat 26.

The structural reinforcement layers 18, 20 are incorporated into the laminate 10 in a preferred embodiment, as described herein. However, any number and combination of structural reinforcement layers, or mats, comprised of carbon fibers may be used in any vehicle panel, and specifically any vehicle headliner or laminate for use in a vehicle headliner in accordance with this invention. The structural reinforcement layers and laminates containing the structural reinforcement layers may be manufactured using any suitable process, including wet laid and dry laid processes.

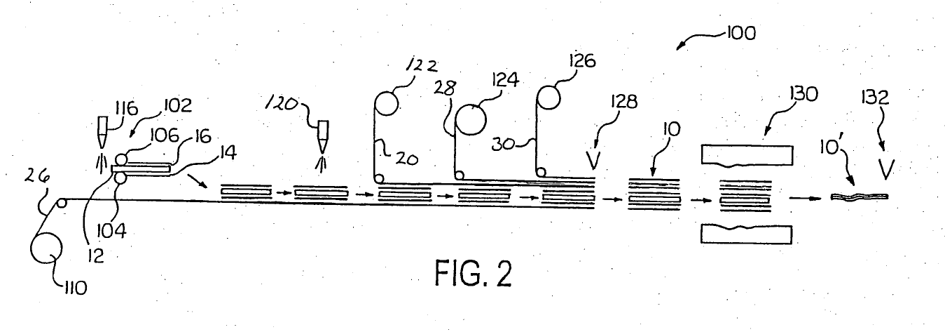

A method of manufacturing the laminate 10 is described with reference to FIG. 2. In an assembly line set-up indicated generally at 100, the core 12 is fed from a stack of blanks (not shown) through a liquid adhesive applicator, generally indicated at 102, at which the adhesive layers 14, 16 are applied to the opposing sides of the core 12 (i.e., the upper and lower sides of the core 12 when viewing FIG. 2). The liquid adhesive applicator 102 may be in the form of a roll coat system comprising upper and lower rollers 104, 106 continuously coated with liquid adhesive supplied from reservoirs or dispensers (not shown). Alternatively, the liquid adhesive may be applied by a knife-over-roller, a curtain, or a spray (not shown). In the former applicators, the adhesive should be applied at a rate sufficient to maintain a small layer of adhesive on the rollers, knife, or curtain to evenly coat the core 12. According to a preferred embodiment of the invention, the adhesive should be applied only to the surface of the core 12 with minimal surface penetration. As stated above, the adhesive layers 14, 16 may alternatively be applied to the reinforcement layers 18, 20, or to both the core 12 and the reinforcement layers 18, 20. It should be appreciated that the core 12 may be continuously fed rather than discretely fed in the form of blanks.

The core 12 with the adhesive layers 14, 16 applied thereto is then conveyed onto the scrim mat 26 carrying a structural reinforcement layer 18 (i.e., on the upper surface of the scrim mat 26 when viewing FIG. 2), a barrier film 22, and a scrim layer 24. The scrim mat 26 may be guided from a spool 110 by a guide roller. The construction of the scrim mat 26 will be described in further detail below, as shown in FIG. 3. However, it will be appreciated that combining the structural reinforcement layer 18, the barrier film 22, and the scrim layer 24 to one another to form the scrim mat 26 prior to incorporation into the laminate 10 is not required. It will be appreciated that alternatively the barrier film 22 and the scrim layer 24 may each be guided from individual spools, and the structural reinforcement layer 18 may be guided from a spool or formed from loose fibers, including carbon fibers laid into a binder or adhesive on or within any of the other layers of the laminate 10. The core 12 is fed at the same rate as the scrim mat 26. The scrim mat 26 may pass a catalyst applicator 116, at which a catalyst, e.g., Forbo 22014, is applied to accelerate the curing of the adhesive layer 14 during the subsequent heat process.

The adhesive-coated core 12 may then pass a catalyst applicator 120, at which a catalyst (e.g., Forbo 22014) may be sprayed onto an exposed side of the core 12 (i.e., an upper side of the core when viewing FIG. 2) and the adhesive layer 16 thereon. The catalyst is applied to accelerate the curing of the adhesive layer 16 during the subsequent heat process. The structural reinforcement layer 20, the barrier film 28 and the covering 30 are guided from spools 122, 124, 126, respectively, onto the adhesive-coated core 12 to complete the laminate 10. The structural reinforcement layer 20 may be a continuous prefabricated mat pulled from the spool 122, as shown. Alternatively, the structural reinforcement layer 20 may be comprised of carbon fibers distributed directly onto the core 12 or any other portion of the laminate 10.

The laminate 10 passes though a cutter 128, where it is cut to a desired length. The laminate 10 is then conveyed to a mold 130. As is known in the art, the mold 130 is heated to a temperature sufficient to cure the liquid adhesive and bind it to the sizing on the fibers and sufficient to melt the barrier film 24. Pressure is preferably applied to compress the laminate 10 to conform to the internal configuration of the mold 130. The molded laminate 10′ may then be cut as desired, for example, to form a completed headliner, by final trimmer 132, which is well known in the art.

It will be appreciated that alternatively, the fibers of the structural reinforcement layers 18, 20, including the carbon fibers, may be supplied from a reservoir and randomly applied to the scrim mat 26 or the core 12, respectively, preferably in a random gravity-fed fashion, such as by sprinkling fibers thereof from an agitator tray or chopper positioned over the scrim mat 26 or core 12. It should be appreciated that the fibers may be applied by manual distribution from a container or cut from continuous strands or rovings directly above the scrim mat 26 or core 12 and allowed to fall randomly upon the scrim mat 26 or core 12. It should also be appreciated that the structural reinforcement layers 18, 20 could be formed from fibers supplied from a reservoir as described above over any layer of the laminate 10, including the film barrier 22 and scrim layer 24 if supplied to the laminate 10 separate from the scrim mat 26.

Referring now to FIG. 3, there is illustrated a method of manufacturing the scrim mat 26. The structural reinforcement layer 18, the barrier film 22, and the scrim layer 24 are guided from spools 134, 136, and 138, respectively, through the upper and lower rollers 140 and 142. The rollers 140, 142 may be guide rollers for aligning the structural reinforcement layer 18, the barrier film 22, and the scrim layer 24 relative to one another. Additionally, or alternatively, the rollers 140, 142 may be hot rollers capable of melting the barrier film 22 such that the structural reinforcement layer 18, the barrier film 22, and the scrim layer 24 are adhered to one another. A catalyst, adhesive, or binder as described above may be sprayed or roll coated onto a portion of the scrim mat 26 to aid in the adhesion of the structural reinforcement layer 18, the barrier film 22, and the scrim layer 24.

One principle advantage of the invention is with regard to recycling the material removed from the laminate 10 by the final trimmer 132, as well as recycling the laminate 10 at the end of the headliner lifecycle. Since the laminate 10 according to the present invention includes reinforcing fibers (e.g., carbon fibers) that have a much higher melting and/or degradation point than the other composite materials, the laminate 10 and trimmings therefrom may be incinerated and energy resulting therefrom may be reclaimed, thus achieving desired or required recycling efforts. In a preferred embodiment, the composite materials of the laminate 10, but for the carbon fibers, are reduced to ash. However, it is to be understood that only a portion of the laminate 10 may be reduced to ash during the incineration/recycling process of this invention. Ash as used throughout this application is to be understood as the residue remaining after combustion of a material. The carbon fibers have a much higher melting point and do not melt, and thus do not coat the incinerator. The ash and carbon fibers can easily be removed from the incinerator. Since the incinerator is not covered with molten fibers, as is the case with glass fibers, the life of the incinerator is prolonged. In a more preferred embodiment, the laminate 10 is incinerated at a temperature below the degradation point of the carbon fibers, such that the carbon fibers may be separated from the ash and removed from the incinerator and reclaimed for further use in any conventional carbon fiber application. It will be appreciated that one of the uses for the reclaimed carbon fibers could be reuse in vehicle headliners or other vehicle panels or components. It will be appreciated that the higher the grade of carbon fibers used, the higher the degradation point of the carbon fibers will be. Therefore, reclaiming reusable carbon fibers that have not been degraded, while incinerating most of the other portions of the laminate 10 during the incineration process, may be easier to accomplish with high grade carbon fibers due to the higher degradation point of the carbon fibers. It will also be appreciated that the higher the grade of carbon fibers used, the more costly the carbon fibers will be. Therefore, more motivation may exist to reclaim high grade carbon fibers. Degradation point as used throughout this application refers to the temperature at which the carbon fibers, or other fibers being referenced, degrade or break-down, such that the fibers would no longer be suited for the uses described herein and/or the conventional uses of the fiber. In a more preferred embodiment, the laminate 10 is incinerated at a temperature below the degradation point of the carbon fibers and any additional fibers, such that the carbon fibers and additional fibers may be separated from the ash and removed from the incinerator and reclaimed for further use. It will be appreciated that the reclaimed carbon fibers and/or additional fibers could then be reused in vehicle components, such as headliners.

Hence, the invention further includes a method of recycling laminate materials including one or more fiber layers, wherein at least a portion of the fibers are carbon fibers having a at least one of a higher melting and degradation point than the other composite materials and the other composite materials are reduced to ash without reducing the fibers to a nonpolycrystalline or degraded state.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicle headliner comprising:
a plurality of carbon fibers; and
a binder for adhering said plurality of carbon fibers to one another thereby forming a mat.

2. The vehicle headliner of claim 1, wherein said plurality of carbon fibers is produced from petroleum pitch.

3. The vehicle headliner of claim 2, wherein said mat further comprises a plurality of natural fibers.

4. The vehicle headliner of claim 3, wherein said plurality of natural fibers includes at least one of sissal, hemp, knaf, flax, and wood fibers.

5. The vehicle headliner of claim 3, wherein said plurality of carbon fibers comprises at least 50% of the total weight of said mat.

6. The vehicle headliner of claim 1 further including:
a core having opposing sides; and
a first structural reinforcement layer adjacent one of said opposing sides,
wherein said mat comprises a second structural reinforcement layer, said second structural reinforcement layer adjacent the other of said opposing sides.

7. The vehicle headliner of claim 6, further including:
a barrier film and a scrim layer adjacent said first structural reinforcement layer.

8. The vehicle headliner of claim 6, further including:
a barrier film and a covering adjacent said second reinforcement layer.

9. The vehicle headliner of claim 6, further including:
a layer of adhesive interposed between said opposing sides of said core and said first and second structural reinforcement layers;
a barrier film and a scrim layer adjacent said first structural reinforcement layer; and
a barrier film and a covering adjacent said second structural reinforcement layer,
wherein said second structural reinforcement layer comprises a plurality of carbon fibers and a binder for adhering said plurality of carbon fibers to one another thereby forming a mat.

10. A method for manufacturing vehicle headliner, comprising the steps of:
a) providing a core having opposing sides;
b) providing an adhesive layer on at least one of said opposing sides of said core; and
c) providing a first structural reinforcement layer adjacent one of said opposing sides of said core, said first structural reinforcement layer including carbon fibers.

11. The method of claim 10, further including the step:
d) providing a barrier film and a covering on said structural reinforcement layer.

12. The method of claim 10, further including the step:
e) providing a scrim mat having a second structural reinforcement layer including carbon fibers, a scrim layer, and a barrier film disposed therebetween adjacent the other of said opposing sides of said core to complete said laminate.

13. The method of claim 12, wherein, in step b), the carbon fibers are applied to the scrim mat to form the first structural reinforcement layer and deposited atop the coated core to form the second structural reinforcement layer.

14. The method of claim 10, wherein said first and second structural reinforcement layers are pre-formed mats of carbon fiber and thermoplastic binder.

15. The method of claim 10, wherein said core is made of a polyurethane resin foam.

16. The method of claim 10, wherein said adhesive layers are liquid adhesive layers.

17. The method of claim 10, wherein the adhesive layers are applied at a rate sufficient to evenly coat the core with minimal surface penetration.

18. A method for recycling laminate material, comprising the steps of:
a) providing a laminate material formed of composite materials including carbon fibers that have at least one of a higher melting point and degradation point than the other composite materials; and
b) heating the laminate to a temperature above the incineration point of the other composite materials to reduce a portion of the composite materials to ash.

19. The method of claim 18, wherein the laminate is heated to a temperature below the degradation point of the carbon fibers in step b), and the carbon fibers that are not degraded are reclaimed to achieve a recycling effort.

20. The method of claim 18, wherein step b) further comprised the steps of placing the laminate in an incinerator prior to heating the laminate and then removing the ash and degraded carbon fibers from the incinerator after heating the laminate for disposal.
